(19) United States
(12) Patent Application Publication
(10) Pub. No.: US 2022/0129014 A1
(43) Pub. Date: Apr. 28, 2022

(54) MOBILITY SERVICE SYSTEM AND MOBILITY SERVICE DELIVERY METHOD

(71) Applicant: TOYOTA JIDOSHA KABUSHIKI KAISHA, Toyota-shi Aichi-ken (JP)

(72) Inventors: Shun Ota, Susono-shi Shizuoka-ken (JP); Takeshi Ishii, Nagoya-shi Aichi-ken (JP)

(21) Appl. No.: 17/508,186

(22) Filed: Oct. 22, 2021

(30) Foreign Application Priority Data
Oct. 26, 2020 (JP) 2020-179155

(51) Int. Cl. G05D 1/10; G05D 1/00; B64C 29/00; G06Q 10/02

(52) U.S. Cl. CPC G05D 1/102; G06Q 10/02; B64C 29/00; G05D 1/0088

(57) ABSTRACT

A mobility service system delivers a mobility service utilizing an electric vertical takeoff and landing aircraft (eVTOL). The mobility service includes a transportation service where a moving body capable of autonomously traveling in a takeoff and landing site takes a passenger to and from an eVTOL landed on the takeoff and landing site. Sensor detection information detected by a sensor installed on the eVTOL includes at least one of an azimuth of the eVTOL and a relative positional relationship between the eVTOL and the moving body. The mobility service system determines a target route of the moving body in the transportation service such that the moving body moves to a side of a boarding door of the eVTOL, based on the sensor detection information and an installation position of the boarding door of the eVTOL.

### CROSS-REFERENCE TO RELATED APPLICATIONS

This application claims priority to Japanese Patent Application No. 2020-179155 filed on Oct. 26, 2020, the entire contents of which are herein incorporated by reference.

### BACKGROUND

### Technical Field

The present disclosure relates to a technique of delivering a mobility service utilizing an electric vertical takeoff and landing aircraft (eVTOL).

### Background Art

Japanese Laid-Open Patent Application Publication No. JP-2019-214370 discloses an electric multi-rotor aircraft. For example, the electric multi-rotor aircraft is an electric vertical takeoff and landing aircraft.

### SUMMARY

In recent years, a concept of MaaS (Mobility as a Service) has been proposed, and a mobility service utilizing a variety of mobility modes (transportation) in an integrated manner has been proposed. It is conceivable to utilize, as the mobility modes, not only a ground mobility mode such as an automobile and a train but also an air mobility mode. In particular, it is conceivable to utilize an eVTOL as the air mobility mode.

It is conceivable that a passenger getting off from an eVTOL landed on a takeoff and landing site walks to a building or a transit point in the takeoff and landing site. It is also conceivable that a passenger walks from a waiting lounge to an eVTOL when boarding the eVTOL. However, some passengers may desire transportation to and from the eVTOL. For example, a physically disabled passenger may desire transportation to and from the eVTOL. To meet such demands is important for the mobility service.

An object of the present disclosure is to provide a technique capable of smoothly performing transportation to and from an eVTOL in a takeoff and landing site.

A first aspect is directed to a mobility service system that delivers a mobility service utilizing an electric vertical takeoff and landing aircraft (eVTOL).

The mobility service includes a transportation service where a moving body capable of autonomously traveling in a takeoff and landing site takes a passenger to and from an eVTOL landed on the takeoff and landing site.

The mobility service system includes one or more processors configure to determine a target route of the moving body in the transportation service.

The one or more processors are further configured to acquire sensor detection information that is detected by a sensor installed on the eVTOL.

The sensor detection information includes at least one of an azimuth of the eVTOL and a relative positional relationship between the eVTOL and the moving body.

The one or more processors are further configured to determine the target route such that the moving body moves to a side of a boarding door of the eVTOL, based on the sensor detection information and an installation position of the boarding door of the eVTOL.

A second aspect is directed to a mobility service delivery method that delivers a mobility service utilizing an electric vertical takeoff and landing aircraft (eVTOL).

The mobility service delivery method is performed by a computer executing a computer program.

The mobility service includes a transportation service where a moving body capable of autonomously traveling in a takeoff and landing site takes a passenger to and from an eVTOL landed on the takeoff and landing site.

The mobility service delivery method includes a target route determination process that determines a target route of the moving body in the transportation service.

The target route determination process includes acquiring sensor detection information that is detected by a sensor installed on the eVTOL.

The sensor detection information includes at least one of an azimuth of the eVTOL and a relative positional relationship between the eVTOL and the moving body.

The target route determination process further includes determining the target route such that the moving body moves to a side of a boarding door of the eVTOL, based on the sensor detection information and an installation position of the boarding door of the eVTOL.

According to the present disclosure, the mobility service includes the transportation service where the moving body capable of autonomously traveling in the takeoff and landing site takes the passenger to and from the eVTOL landed on the takeoff and landing site. The target route of the moving body at the time of the transportation service is determined such that the moving body can move to the side of the boarding door of the eVTOL. As a result, a smooth transportation service is achieved.

### BRIEF DESCRIPTION OF DRAWINGS

FIG. 1 is a conceptual diagram for explaining an outline of a mobility service;

FIG. 2 shows a variety of examples of combinations of mobility modes utilizing an eVTOL;

FIG. 3 is a schematic diagram showing a configuration of a mobility service system;

FIG. 4 is a block diagram showing a configuration example of an eVTOL;

FIG. 5 is a block diagram showing a configuration example of a pilot terminal;

FIG. 6 is a block diagram showing a configuration example of a takeoff and landing site;

FIG. 7 is a block diagram showing a configuration example of a local terminal;

FIG. 8 is a block diagram showing a configuration example of a user terminal;

FIG. 9 is a block diagram showing a configuration example of a management server;

FIG. 10 is a block diagram showing an example of user information;

FIG. 11 is a block diagram showing an example of eVTOL service management information;

FIG. 12 is a conceptual diagram showing an example of takeoff and landing site information;

FIG. 13 is a flow chart showing a reservation process performed by a management server;

FIG. 14 is a flow chart showing a first example of an itinerary planning process (Step S200);

FIG. 15 is a flow chart showing an example of Step S220;

FIG. 16 is a flow chart showing a second example of the itinerary planning process (Step S200);

FIG. 17 is a flow chart showing a third example of the itinerary planning process (Step S200);

FIG. 18 is a conceptual diagram showing an example of information displayed on a display device in an itinerary presentation process (Step S300);

FIG. 19 is a conceptual diagram showing another example of information displayed on the display device in the itinerary presentation process (Step S300);

FIG. 20 is a conceptual diagram for explaining a transportation service in a takeoff and landing site;

FIG. 21 is a perspective view showing a configuration example of a moving body used for the transportation service in the takeoff and landing site;

FIG. 22 is a block diagram showing a configuration example of the moving body;

FIG. 23 is a conceptual diagram for explaining a target route of a moving body depending on an azimuth of an eVTOL;

FIG. 24 is a conceptual diagram for explaining an example of a sensor installed on an eVTOL; and

FIG. 25 is a flow chart showing processing related to the transportation service.

### DETAILED DESCRIPTION

Embodiments of the present disclosure will be described with reference to the accompanying drawings.

### 1. MOBILITY SERVICE

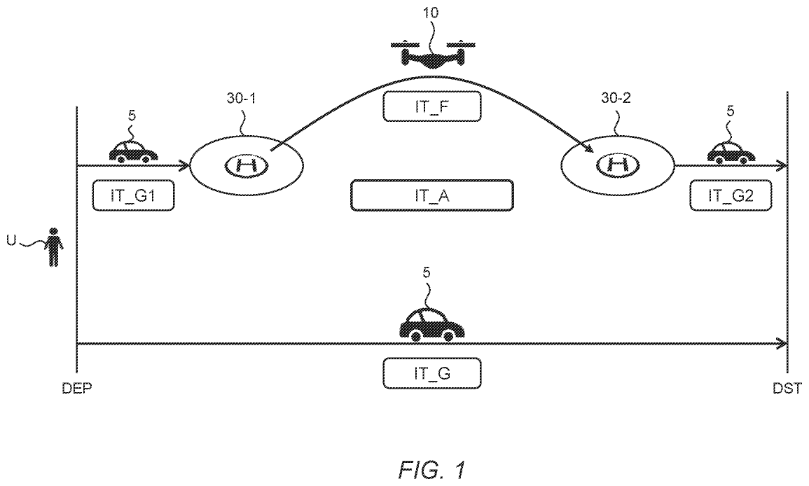

FIG. 1 is a conceptual diagram for explaining an outline of a mobility service according to the present embodiment. The mobility service utilizes a variety of mobility modes (transportation) in an integrated manner. A general mobility service utilizes a ground mobility mode 5 such as an automobile, a train, and the like. Examples of the automobile include a taxi, a bus, a ride-sharing vehicle, a MaaS vehicle, and the like.

According to the present embodiment, not only the ground mobility mode 5 but also an air mobility mode is used for the mobility service. In particular, an electric vertical takeoff and landing aircraft (eVTOL) 10 is used as the air mobility mode. Hereinafter, eVTOL means an electric vertical takeoff and landing aircraft. The eVTOL 10 is a compact and lightweight VTOL driven by an electric motor. Such the eVTOL 10 is characterized by space-saving, lower costs, and lower noise as compared with a usual aircraft. For example, the eVTOL 10 is useful for an air taxi business where movement for a relatively short distance is repeated at a high frequency.

A takeoff and landing site 30 is a place for the eVTOL 10 to take off or land. Examples of the takeoff and landing site 30 include an airport, an airdrome, a heliport, a roof of a building, an eVTOL hangar, and the like.

As a still another example, the takeoff and landing site 30 may be an auto dealer. In that case, a space for the eVTOL 10 to take off and land is provided in the grounds of the dealer. Utilizing the dealer as the takeoff and landing site 30 makes it possible to seamlessly connect the ground mobility service utilizing the automobile and the air mobility service utilizing the eVTOL 10. In addition, it enables an one-stop service providing the both mobility services. Furthermore, utilizing a dealer network makes it possible to construct a mobility service network. Similarly, the takeoff and landing site 30 may be a car rental office.

A case where a user U uses the mobility service for moving from a point of departure DEP to a destination DST as shown in FIG. 1 is considered. One option is to move from the point of departure DEP to the destination DST by using the ground mobility mode 5 such as an automobile. An itinerary using only the ground mobility mode 5 is hereinafter referred to as an “itinerary IT_G.” Another option is to move from the point of departure DEP to the destination DST by using the eVTOL 10 as well. An itinerary using the eVTOL 10 is hereinafter referred to as an “itinerary IT_A.”

An example of the itinerary IT_A is as follows. A first takeoff and landing site 30-1 is a takeoff and landing site 30 on a side of the point of departure DEP, and a second takeoff and landing site 30-2 is a takeoff and landing site 30 on a side of the destination DST. For example, the first takeoff and landing site 30-1 is a takeoff and landing site 30 nearest to the point of departure DEP, and the second takeoff and landing site 30-2 is a takeoff and landing site 30 nearest to the destination DST. The user U moves from the point of departure DEP to the first takeoff and landing site 30-1 by using the ground mobility mode 5 (itinerary IT_G1). Subsequently, the user U moves from the first takeoff and landing site 30-1 to the second takeoff and landing site 30-2 by using the eVTOL 10 (itinerary IT_F). Then, the user U moves from the second takeoff and landing site 30-2 to the destination DST by using the ground mobility mode 5 (itinerary IT_G2). The itinerary IT_A is a combination of the three itineraries IT_G1, IT_F, and IT_G2.

The user U can select a one from the itinerary IT_G and the itinerary IT_A. For example, the user U selects an itinerary in consideration of a required time and a usage fee. As described above, the mobility service utilizing not only the ground mobility mode 5 but also the eVTOL 10 is able to offer the user U a variety of options.

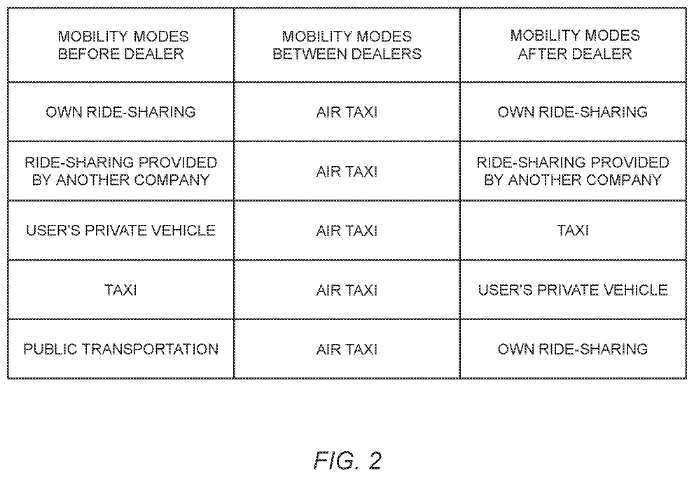

FIG. 2 shows a variety of examples of combinations of mobility modes utilizing the eVTOL 10. In the example shown in FIG. 2, the takeoff and landing site 30 is a dealer. The mobility modes between dealers (i.e., the first takeoff and landing site 30-1 and the second takeoff and landing site 30-2) is, for example, an air taxi utilizing the eVTOL 10. Examples of the mobility modes before and after the dealers include ride-sharing, a private vehicle of the user U, a taxi, a public transportation, and the like. In this manner, a variety of combinations of the mobility modes are possible.

Hereinafter, a “mobility service system” that delivers the mobility service according to the present embodiment will be described in detail.

### 2. MOBILITY SERVICE SYSTEM

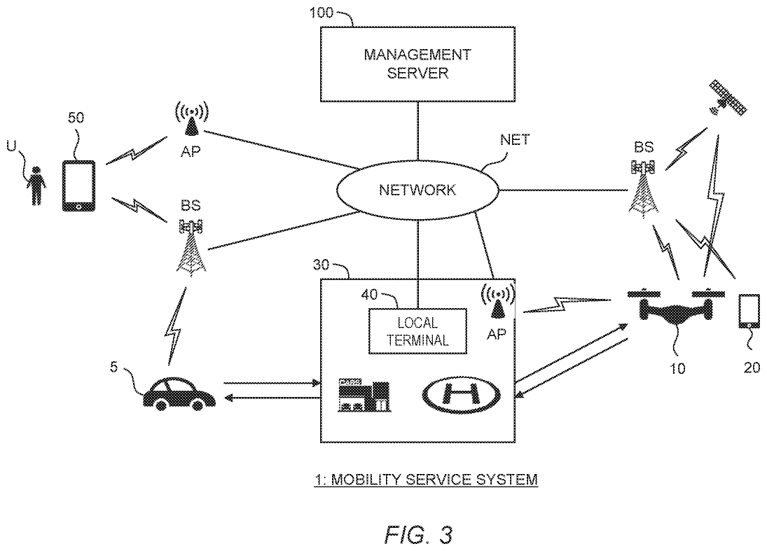

FIG. 3 is a schematic diagram showing a configuration of a mobility service system 1 according to the present embodiment. The mobility service system 1 includes the ground mobility modes 5, the eVTOL 10, a pilot terminal 20, the takeoff and landing site 30, a local terminal 40, a user terminal 50 of the user U, a management server 100 (central server), and a communication network NET. The number of eVTOLs 10 and the number of takeoff and landing sites 30 are arbitrary. For instance, a large number of eVTOLs 10 and a larger number of takeoff and landing sites 30 are utilized.

Each mobility modes and each device can be connected to the communication network NET and can communicate via the communication network NET. For example, the ground mobility modes 5 can be connected to the communication network NET via a wireless base station BS. The eVTOL 10 and the pilot terminal 20 each can be connected to the communication network NET via a wireless base station BS. The eVTOL 10 and the pilot terminal 20 each can be connected to the communication network NET via an access point AP of a wireless LAN (Local Area Network) installed in the takeoff and landing site 30. The eVTOL 10 may perform communication using satellite communication or a dedicated line. The local terminal 40 can be connected to the communication network NET by wire or via an access point AP of a wireless LAN. The user terminal 50 can be connected to the communication network NET via a wireless base station BS or an access point AP of a wireless LAN. The management server 100 can be connected to the communication network NET by wire or via an access point AP of a wireless LAN.

Hereinafter, each component of the mobility service system 1 according to the present embodiment will be described in more detail.

### 2-1. eVTOL 10

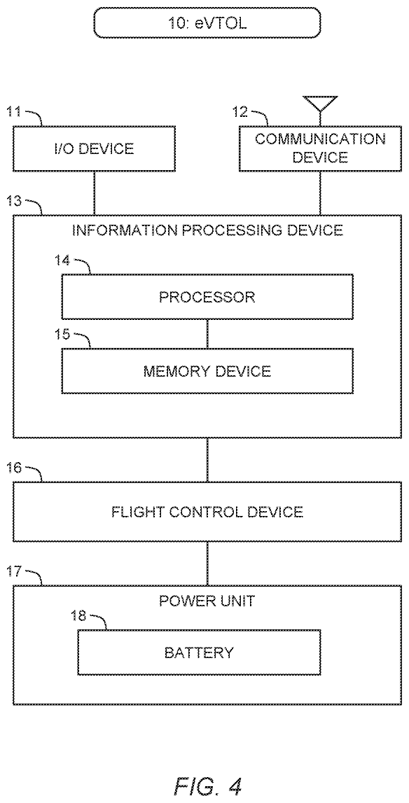

FIG. 4 is a block diagram showing a configuration example of the eVTOL 10 according to the present embodiment. The eVTOL 10 includes an input/output device 11, a communication device 12, an information processing device 13, a flight control device 16, and a power unit 17.

The input/output device 11 is an interface for receiving information from a pilot of the eVTOL 10 and for providing information to the pilot. Examples of the input device include a keyboard, a mouse, a touch panel, a switch, a microphone, and the like. Examples of the output device include a display device, a speaker, and the like.

The communication device 12 performs communication with the outside. For example, the communication device 12 performs wireless communication with the wireless base station BS and the access point AP. As another example, the communication device 12 may perform near field communication with the user terminal 50. As yet another example, during a flight of the eVTOL 10, the communication device 12 may perform communication using satellite communication or a dedicated line.

The information processing device 13 executes a variety of information processing. For example, the information processing device 13 includes one or more processors 14 and one or more memory devices 15. The processor 14 executes a variety of information processing. For example, the processor 14 includes a CPU (Central Processing Unit). The memory device 15 stores a variety of information necessary for the processing by the processor 14. Examples of the memory device 15 include a volatile memory, a non-volatile memory, an HDD (Hard Disk Drive), an SSD (Solid State Drive), and the like. Functions of the information processing device 13 are achieved by the processor 14 executing a computer program. The computer program is stored in the memory device 15. The computer program may be recorded on a computer-readable recording medium. The computer program may be provided via a network.

The flight control device 16 controls the flight of the eVTOL 10 by controlling the power unit 17.

The power unit 17 includes an electric motor for rotating a rotor of the eVTOL 10, a battery 18 for supplying electric power to the electric motor, and the like. For example, the battery 18 is a storage battery such as an all-solid-state battery and the like. Alternatively, the battery 18 may be a fuel cell. In the following description, “charging the battery 18” means “charging the storage battery”. When the eVTOL 10 is equipped with the fuel cell, “charging the battery 18” is realized by “supplying hydrogen to the fuel cell.”

### 2-2. Pilot Terminal 20

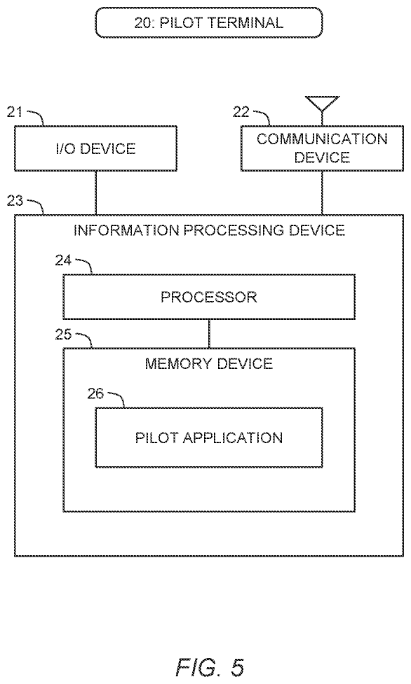

FIG. 5 is a block diagram showing a configuration example of the pilot terminal 20 according to the present embodiment. The pilot terminal 20 is a terminal used by the pilot of the eVTOL 10. For example, the pilot terminal 20 is a smartphone. The pilot terminal 20 includes an input/output device 21, a communication device 22, and an information processing device 23.

The input/output device 21 is an interface for receiving information from the pilot of the eVTOL 10 and for providing information to the pilot. Examples of the input device include a touch panel, a camera, a microphone, and the like. Examples of the output device include a display device, a speaker, and the like.

The communication device 22 performs communication with the outside. For example, the communication device 22 performs wireless communication with the wireless base station BS and the access point AP. As another example, the communication device 22 may perform near field communication with the user terminal 50.

The information processing device 23 executes a variety of information processing. For example, the information processing device 23 includes one or more processors 24 and one or more memory devices 25. The processor 24 executes a variety of information processing. For example, the processor 24 includes a CPU. The memory device 25 stores a variety of information necessary for the processing by the processor 24. Examples of the memory device 25 include a volatile memory, a non-volatile memory, and the like. Functions of the information processing device 23 are achieved by the processor 24 executing a computer program. The computer program is stored in the memory device 25. The computer program may be recorded on a computer-readable recording medium. The computer program may be provided via a network.

The computer program includes a pilot application 26. The pilot application 26 provides the pilot with functions necessary for delivering the mobility service. The functions necessary for delivering the mobility service are achieved by the processor 24 executing the pilot application 26.

### 2-3. Takeoff And Landing Site 30

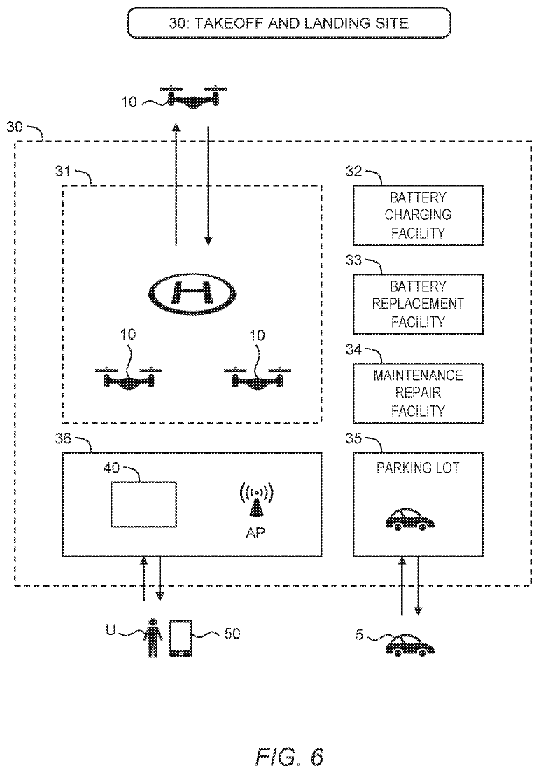

FIG. 6 is a block diagram showing a configuration example of the takeoff and landing site 30 according to the present embodiment. The takeoff and landing site 30 includes at least a takeoff and landing space 31. The takeoff and landing space 31 is a space for the eVTOL 10 to take off and land.

The takeoff and landing site 30 may include at least one of a battery charging facility 32, a battery replacement facility 33, and a maintenance/repair facility 34. The battery charging facility 32 is a facility for charging the battery 18 of the eVTOL 10. The battery replacement facility 33 is a facility for replacing the battery 18 of the eVTOL 10. The maintenance/repair facility 34 is a facility for performing maintenance and repair of the eVTOL 10.

The takeoff and landing site 30 may include a parking lot 35 for parking automobiles. The user U can access the takeoff and landing site 30 by using an automobile. The takeoff and landing site 30 may also offer a mobility service utilizing an automobile. The takeoff and landing site 30 may be an auto dealer, a car rental office, or the like.

The takeoff and landing site 30 may include a management facility 36. The management facility 36 is a facility for managing the mobility service delivered to the user U at the takeoff and landing site 30. For example, the user U checks in the eVTOL 10 at the management facility 36. As another example, at the management facility 36, the user U performs a procedure for using the ground mobility modes 5 such as the automobile. The management facility 36 may be provided with the local terminal 40, the access point AP of the wireless LAN, and the like. The local terminal 40 is a management terminal for managing the mobility service delivered to the user U at the management facility 36.

### 2-4. Local Terminal 40

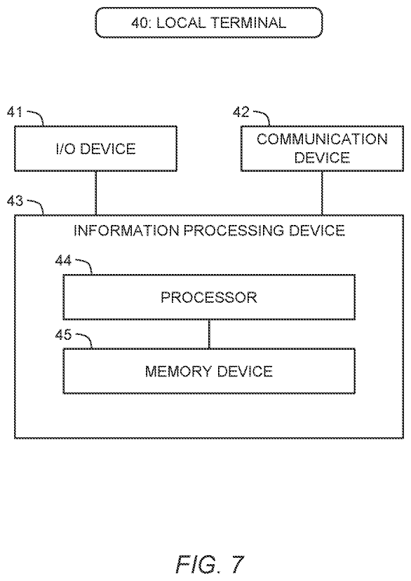

FIG. 7 is a block diagram showing a configuration example of the local terminal 40 according to the present embodiment. The local terminal 40 is a management terminal installed in the takeoff and landing site 30. The local terminal 40 includes an input/output device 41, a communication device 42, and an information processing device 43.

The input/output device 41 is an interface for receiving information from an operator of the local terminal 40 and providing information to the operator. Examples of the input device include a keyboard, a mouse, a touch panel, a switch, a microphone, and the like. Examples of the output device include a display device, a speaker, and the like.

The communication device 42 performs communication with the outside. For example, the communication device 42 performs wire communication. As another example, the communication device 42 may perform near field communication with the user terminal 50.

The information processing device 43 executes a variety of information processing. For example, the information processing device 43 includes one or more processors 44 and one or more memory devices 45. The processor 44 executes a variety of information processing. For example, the processor 44 includes a CPU. The memory device 45 stores a variety of information necessary for the processing by the processor 44. Examples of the memory device 45 include a volatile memory, a non-volatile memory, an HDD, an SSD, and the like. Functions of the information processing device 43 are achieved by the processor 44 executing a computer program. The computer program is stored in the memory device 45. The computer program may be recorded on a computer-readable recording medium. The computer program may be provided via a network.

### 2-5. User Terminal 50

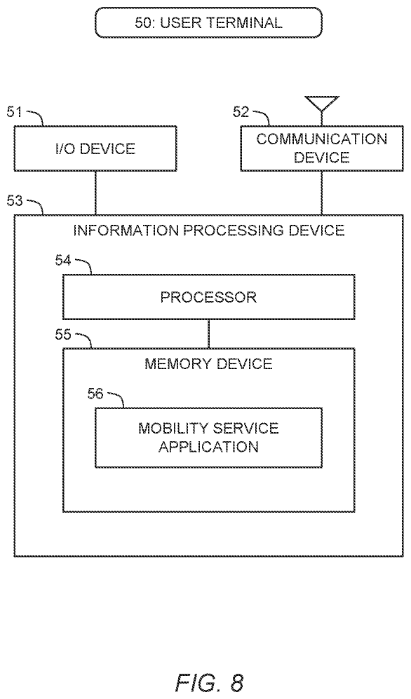

FIG. 8 is a block diagram showing a configuration example of the user terminal 50 according to the present embodiment. The user terminal 50 is a terminal used by the user U. For example, the user terminal 50 is a smartphone. The user terminal 50 includes an input/output device 51, a communication device 52, and an information processing device 53.

The input/output device 51 is an interface for receiving information from the user U and for providing information to the user U. Examples of the input device include a touch panel, a camera, a microphone, and the like. Examples of the output device include a display device, a speaker, and the like.

The communication device 52 performs communication with the outside. For example, the communication device 52 performs wireless communication with the wireless base station BS and the access point AP. As another example, the communication device 52 may perform near field communication with the pilot terminal 20 and the local terminal 40.

The information processing device 53 executes a variety of information processing. For example, the information processing device 53 includes one or more processors 54 and one or more memory devices 55. The processor 54 executes a variety of information processing. For example, the processor 54 includes a CPU. The memory device 55 stores a variety of information necessary for the processing by the processor 54. Examples of the memory device 55 include a volatile memory, a non-volatile memory, and the like. Functions of the information processing device 53 are achieved by the processor 54 executing a computer program. The computer program is stored in the memory device 55. The computer program may be recorded on a computer-readable recording medium. The computer program may be provided via a network.

The computer program includes a mobility service application 56. The mobility service application 56 provides the user U with functions necessary for utilizing the mobility service. The functions necessary for utilizing the mobility service are achieved by the processor 54 executing the mobility service application 56.

### 2-6. Management Server 100

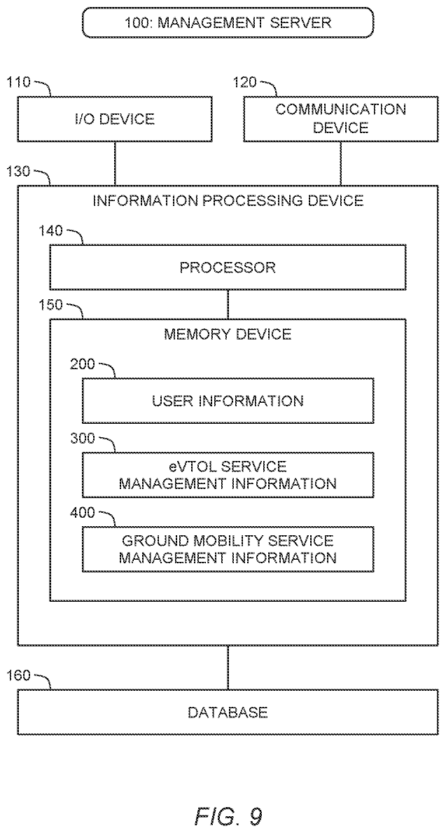

FIG. 9 is a block diagram showing a configuration example of the management server 100 according to the present embodiment. The management server 100 manages the entire mobility service and delivers the mobility service to the user U. The management server 100 may be a distributed server. The management server 100 includes an input/output device 110, a communication device 120, and an information processing device 130.

The input/output device 110 is an interface for receiving information from an operator of the management server 100 and providing information to the operator. Examples of the input device include a keyboard, a mouse, a touch panel, a switch, a microphone, and the like. Examples of the output device include a display device, a speaker, and the like.

The communication device 120 performs communication with the outside. For example, the communication device 120 performs wire communication.

The information processing device 130 executes a variety of information processing. For example, the information processing device 130 includes one or more processors 140 and one or more memory devices 150. The processor 140 executes a variety of information processing. For example, the processor 140 includes a CPU. The memory device 150 stores a variety of information necessary for the processing by the processor 140. Examples of the memory device 150 include a volatile memory, a non-volatile memory, an HDD, an SSD, and the like. Functions of the information processing device 130 are achieved by the processor 140 executing a computer program. The computer program is stored in the memory device 150. The computer program may be recorded on a computer-readable recording medium. The computer program may be provided via a network.

Moreover, the information processing device 130 is accessible to a database 160. The database 160 is realized by a predetermined memory device. The database 160 may be included in the memory device 150 of the management server 100. Alternatively, the database 160 may exist outside the management server 100. The database 160 stores a variety of information necessary for delivering the mobility service. The information processing device 130 reads necessary information from the database 160 and stores it in the memory device 150.

The information necessary for delivering the mobility service includes user information 200, eVTOL service management information 300, and ground mobility service management information 400. The information processing device 130 executes an “information acquisition process” that acquires the user information 200, the eVTOL service management information 300, and the ground mobility service management information 400.

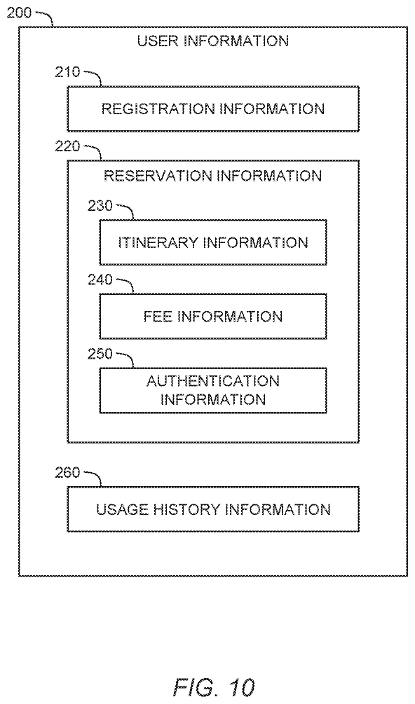

FIG. 10 is a block diagram showing an example of the user information 200. The user information 200 is information related to the user U. For example, the user information 200 includes registration information 210, reservation information 220, and usage history information 260.

The registration information 210 includes an ID and a name of the user U. The registration information 210 is registered in advance by the user U. For example, the user U operates the user terminal 50 to input the registration information 210. The user terminal 50 transmits the registration information 210 to the management server 100. The information processing device 130 receives the registration information 210 via the communication device 120, and records the registration information 210 in the database 160.

The reservation information 220 is information about the mobility service reserved by the user U. The information processing device 130 generates the reservation information 220 in response to a reservation request from the user U. Details of the reservation process will be described later.

The reservation information 220 includes at least itinerary information 230. The itinerary information 230 indicates the itinerary of the mobility service used by user U. For example, the itinerary information 230 includes a point of departure DEP, a destination DST, a route, mobility modes to be used, takeoff and landing sites 30 to be used, a time of departure, a time of arrival, a required time from the point of departure DEP to the destination DST, and the like.

The reservation information 220 may include fee information 240. The fee information 240 indicates a usage fee of the mobility service used by the user U.

The reservation information 220 may include authentication information 250. The authentication information 250 is information used for authenticating the user U when the user U boards the reserved mobility modes. The authentication information 250 includes an authentication code. The authentication information 250 may be a QR code (registered trademark).

The usage history information 260 indicates a history of the mobility service used by the user U.

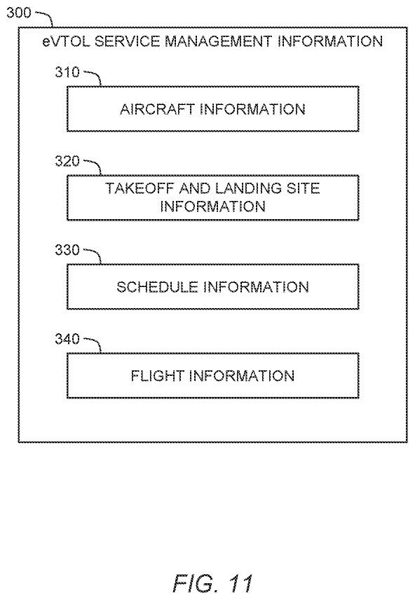

FIG. 11 is a block diagram showing an example of the eVTOL service management information 300. The eVTOL service management information 300 is information for managing the mobility service that utilizes the eVTOL 10. For example, the eVTOL service management information 300 includes aircraft information 310, takeoff and landing site information 320, schedule information 330, and flight information 340.

The aircraft information 310 is information on each of one or more eVTOLs 10 used for the mobility service. More specifically, the aircraft information 310 includes an aircraft ID, performance information, and the like of each eVTOL 10. The performance information includes a flight range, a maximum flight speed, and the like. The flight range is the maximum distance for which the eVTOL 10 is able to fly without being charged halfway. In addition, the performance information includes “battery performance information” regarding performance of the battery 18 of the eVTOL 10. The battery performance information includes a maximum battery capacity, a remaining battery level, a charging time required to charge the battery 18 to full capacity, and the like. Furthermore, the battery performance information indicates whether the eVTOL 10 is an aircraft whose battery 18 is replaceable.

The takeoff and landing site information 320 is information on each of one or more takeoff and landing sites 30 used for the mobility service. More specifically, the takeoff and landing site information 320 includes a location (latitude and longitude) of each takeoff and landing site 30. In addition, the takeoff and landing site information 320 includes a facility ability of each takeoff and landing site 30. For example, the takeoff and landing site information 320 indicates presence or absence of the battery charging facility 32, presence or absence of the battery replacement facility 33, presence or absence of the maintenance/repair facility 34, presence or absence of the parking lot 35, and the like (see FIG. 6).

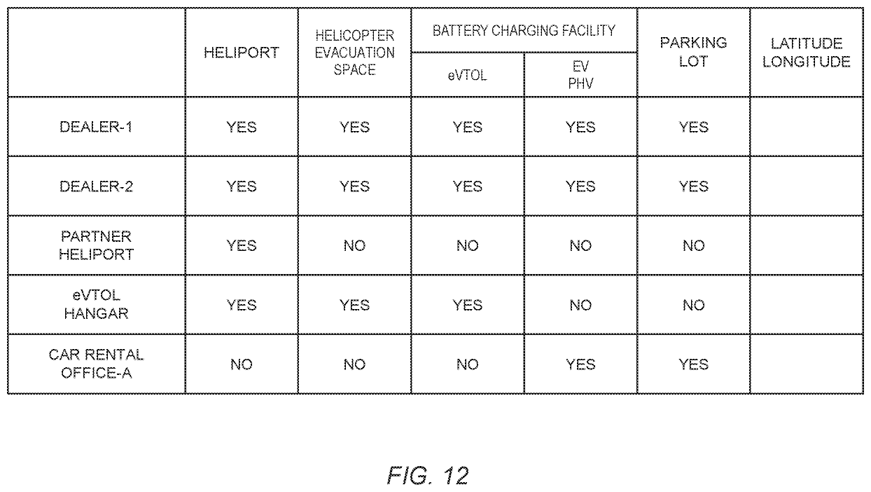

FIG. 12 shows an example of the takeoff and landing site information 320. Examples of the takeoff and landing site 30 include a dealer, a partner heliport, an eVTOL hangar, and a car rental office. The takeoff and landing site information 320 indicates presence or absence of a heliport, presence or absence of a helicopter evacuation space, presence or absence of the battery charging facility 32, presence or absence of the parking lot 35, and the latitude/longitude, for each takeoff and landing site 30.

The schedule information 330 includes at least one of a schedule of each eVTOL 10 and a schedule of each takeoff and landing site 30. The schedule of each eVTOL 10 indicates when and where each eVTOL 10 exists. For example, the schedule of each eVTOL 10 indicates a period of time when each eVTOL 10 exists at a takeoff and landing site 30, the takeoff and landing site 30, a period of time when each eVTOL 10 is in flight, a period of time when each eVTOL 10 is under maintenance, and the like. The schedule of each takeoff and landing site 30 indicates when and which eVTOL 10 is present (available) at each takeoff and landing site 30. In addition, the schedule of each takeoff and landing site 30 indicates a usage schedule and availability of the battery charging facility 32, the battery replacement facility 33, the maintenance/repair facility 34, and the like.

The flight information 340 is information on a flight of the eVTOL 10. For example, the flight information 340 includes a flight route, a position, an altitude, a flight speed, and the like of the eVTOL 10. Such the flight information 340 may be acquired in real time during the flight or may be acquired after the flight. In either case, the past flight information 340 is recorded in the database 160.

The ground mobility service management information 400 is information for managing the mobility service that utilizes the ground mobility modes 5. More specifically, the ground mobility service management information 400 indicates a type and a schedule of the ground mobility modes 5. For example, when the ground mobility modes 5 is an automobile, the ground mobility service management information 400 indicates an ID, a vehicle type, a schedule (e.g., a location, a usage status, a reservation status), and the like of the automobile.

### 3. RESERVATION PROCESS

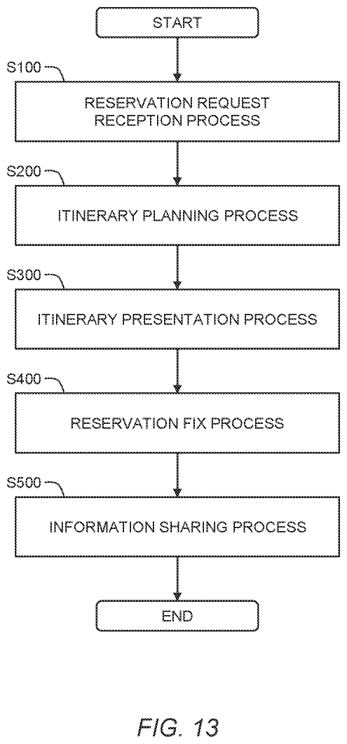

The management server 100 (i.e., the information processing device 130) according to the present embodiment executes a “reservation process” that accepts a reservation of the mobility service requested from the user U. FIG. 13 is a flow chart showing the reservation process. Hereinafter, the reservation process according to the present embodiment will be described in detail. It should be noted that the eVTOL service management information 300 and the ground mobility service management information 400 are already acquired by the above-described information acquisition process and stored in the database 160 and the memory device 150.

### 3-1. Step S100 (Reservation Request Reception Process)

First, the information processing device 130 executes a “reservation request reception process” that receives a reservation request REQ from the user U. For example, the reservation request REQ includes a desired date of usage, a desired time of departure, a desired time of arrival, a point of departure DEP, a destination DST, and the like. The reservation request REQ may specify a desired mobility modes (e.g., eVTOL 10). The reservation request REQ corresponds to “search information” used by the user U for searching for the mobility service.

The user U inputs the reservation request REQ (i.e., the search information) by the use of the input/output device 51 of the user terminal 50. The information processing device 53 of the user terminal 50 transmits the input reservation request REQ to the management server 100 via the communication device 52. The information processing device 130 of the management server 100 receives the reservation request REQ via the communication device 120. The information processing device 130 stores the received reservation request REQ in the memory device 150.

### 3-2. Step S200 (Itinerary Planning Process)

In response to the reservation request REQ, the information processing device 130 executes an “itinerary planning process” that plans an itinerary from the point of departure DEP to the destination DST. The itinerary planning process is executed based on the eVTOL service management information 300 and the ground mobility service management information 400 described above.

### 3-2-1. First Example

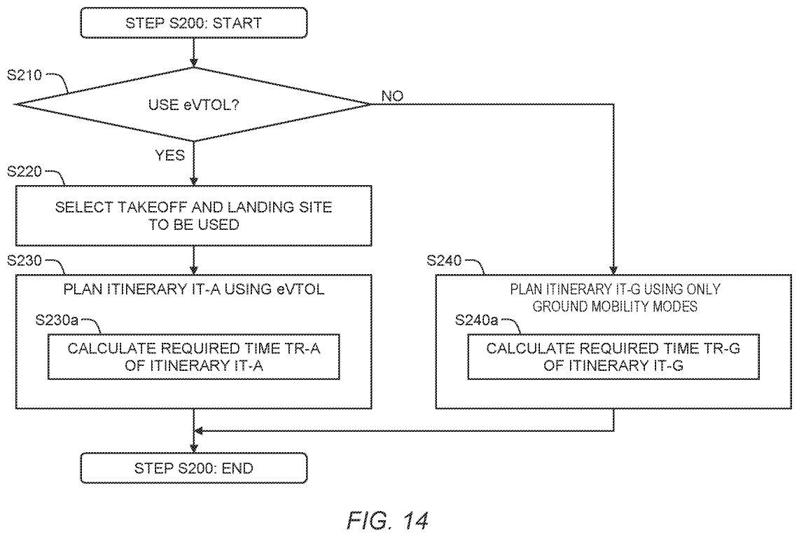

FIG. 14 is a flow chart showing a first example of the itinerary planning process (Step S200).

In Step S210, the information processing device 130 determines whether or not the reservation request REQ specifies the use of the eVTOL 10. In other words, the information processing device 130 determines whether or not the user U desires to use the eVTOL 10. When the use of the eVTOL 10 is specified (Step S210; Yes), the processing proceeds to Step S220. On the other hand, when the use of the eVTOL 10 is not specified (Step S210; No), the processing proceeds to Step S240.

In Step S220, the information processing device 130 selects the takeoff and landing sites 30 to be used. As described in FIG. 1, the first takeoff and landing site 30-1 is a takeoff and landing site 30 on the side of the point of departure DEP, and the second takeoff and landing site 30-2 is a takeoff and landing site 30 on the side of the destination DST. For example, the information processing device 130 sets a takeoff and landing site 30 nearest to the point of departure DEP as the first takeoff and landing site 30-1, and sets a takeoff and landing site 30 nearest to the destination DST as the second takeoff and landing site 30-2. The location (latitude and longitude) of each takeoff and landing site 30 is included in the takeoff and landing site information 320. Therefore, the information processing device 130 can select (set) the takeoff and landing sites 30 to be used, based on the takeoff and landing site information 320 and the point of departure DEP and the destination DST indicated by the reservation request REQ.

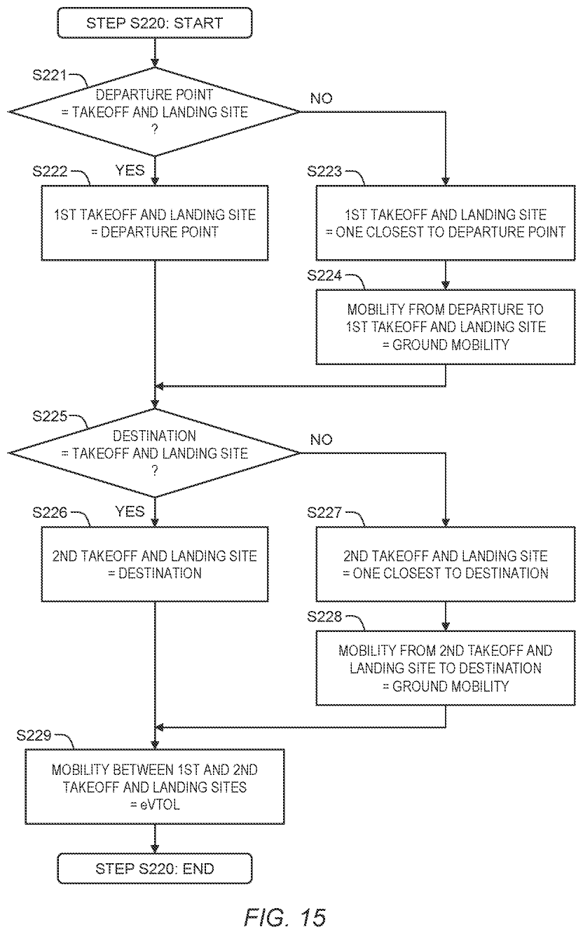

FIG. 15 is a flow chart showing an example of Step S220.

In Step S221, the information processing device 130 determines whether or not the point of departure DEP is any takeoff and landing site 30. When the point of departure DEP is any takeoff and landing site 30 (Step S221; Yes), the information processing device 130 sets the point of departure DEP as the first takeoff and landing site 30-1 (Step S222). On the other hand, when the point of departure DEP is not a takeoff and landing site 30 (Step S221; No), the information processing device 130 sets a takeoff and landing site 30 nearest to the point of departure DEP as the first takeoff and landing site 30-1 (Step S223). In other words, the information processing device 130 adds the takeoff and landing site 30 nearest to the point of departure DEP as a transfer point. Then, the information processing device 130 sets the mobility modes from the point of departure DEP to the first takeoff and landing site 30-1 to the ground mobility modes 5 such as an automobile (Step S224).

In Step S225, the information processing device 130 determines whether or not the destination DST is any takeoff and landing site 30. When the destination DST is any takeoff and landing site 30 (Step S225; Yes), the information processing device 130 sets the destination DST as the second takeoff and landing site 30-2 (Step S226). On the other hand, when the destination DST is not a takeoff and landing site 30 (Step S225; No), the information processing device 130 sets a takeoff and landing site 30 nearest to the destination DST as the second takeoff and landing site 30-2 (Step S227). In other words, the information processing device 130 adds the takeoff and landing site 30 nearest to the destination DST as a transfer point. Then, the information processing device 130 sets the mobility modes from the second takeoff and landing site 30-2 to the destination DST to the ground mobility modes 5 such as an automobile (Step S228).

In Step S229, the information processing device 130 sets the mobility modes from the first takeoff and landing site 30-1 to the second takeoff and landing site 30-2 to the eVTOL 10. After that, the processing proceeds to Step S230.

In Step S230, the information processing device 130 plans (creates) the “itinerary IT_A” that uses the eVTOL 10. The itinerary IT_A includes a flight from the first takeoff and landing site 30-1 to the second takeoff and landing site 30-2. For example, the itinerary IT_A is a combination of the itinerary IT_G1 to move from the point of departure DEP to the first takeoff and landing site 30-1 by the ground mobility modes 5, the itinerary IT _F to move from the first takeoff and landing site 30-1 to the second takeoff and landing site 30-2 by the eVTOL 10, and the itinerary IT_G2 to move from the second takeoff and landing site 30-2 to the destination DST by the ground mobility modes 5 (see FIG. 1). The information processing device 130 can plan the itinerary IT_A based on the eVTOL service management information 300 (especially, the schedule information 330) and the ground mobility service management information 400.

In addition, in Step S230, the information processing device 130 calculates a required time TR-A from the point of departure DEP to the destination DST in the case of the itinerary IT-A (Step S230a).

On the other hand, in Step S240, the information processing device 130 plans (creates) the “itinerary IT_G” that uses only the ground mobility modes 5 (see FIG. 1). The information processing device 130 can plan the itinerary IT_G based on the ground mobility service management information 400.

In addition, in Step S240, the information processing device 130 calculates a required time TR-G from the point of departure DEP to the destination DST in the case of the itinerary IT-G (Step S240a).

### 3-2-2. Second Example

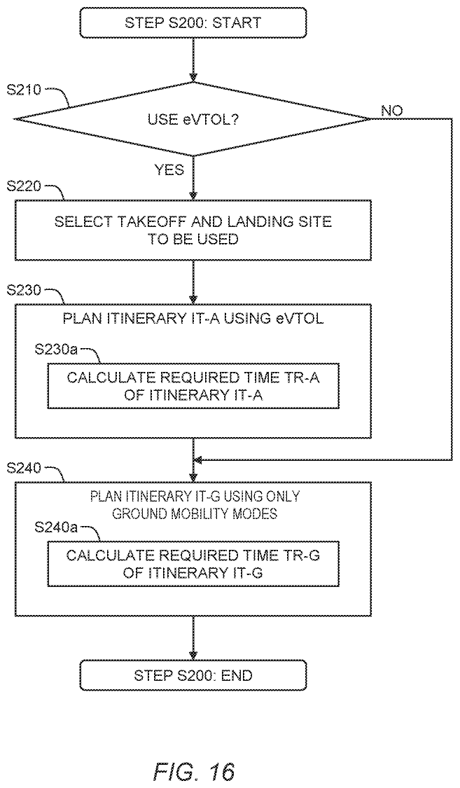

FIG. 16 is a flow chart showing a second example of the itinerary planning process (Step S200). An overlapping description with the first example described in FIG. 14 will be omitted. When the use of the eVTOL 10 is specified (Step S210; Yes), only the itinerary IT-A is planned in the case of the first example, but in the second example, both the itinerary IT_A and the itinerary IT_G are planned. To that end, Step S240 is performed after Step S230. Since both the itinerary IT_A and the itinerary IT_G are planned, it is possible in an itinerary presentation process (Step S300) described later to present both the itinerary IT_A and the itinerary IT_G such that the user U is able to compare them.

### 3-2-3. Third Example

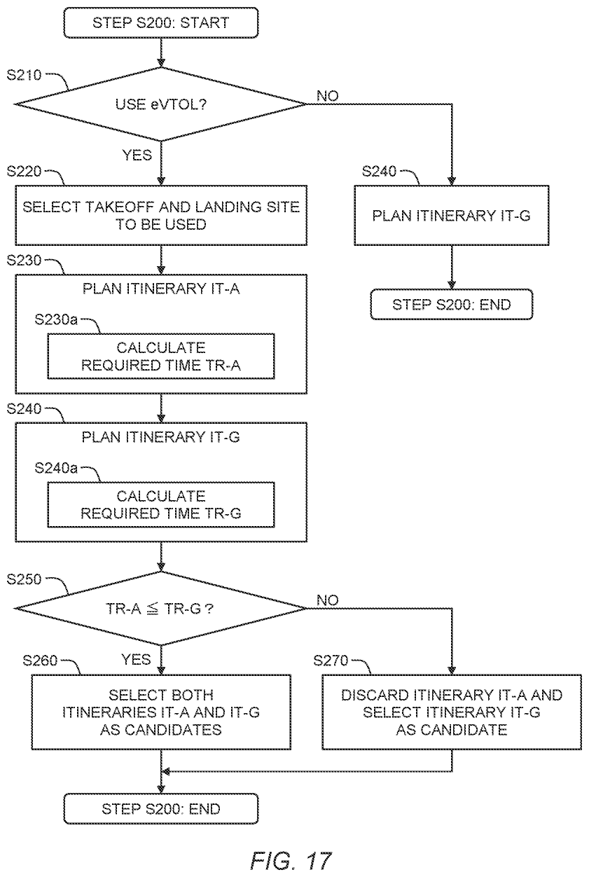

FIG. 17 is a flow chart showing a third example of the itinerary planning process (Step S200). The third example is a modification example of the second example shown in FIG. 16. As described above, when the use of the eVTOL 10 is specified (Step S210; Yes), the information processing device 130 plans both the itinerary IT-A and the itinerary IT-G (Steps S230 and S240). Furthermore, in Step S250, the information processing device 130 compares the required time TR-A of the itinerary IT-A and the required time TR-G of the itinerary IT-G. When the required time TR-A is equal to or less than the required time TR-G (Step S250; Yes), the information processing device 130 selects both the itinerary IT-A and the itinerary IT-G as candidates (Step S260). On the other hand, when the required time TR-A is longer than the required time TR-G (Step S250; No), the information processing device 130 discards the itinerary IT-A and selects the itinerary IT-G as a candidate (Step S270).

### 3-2-4. Itinerary Information

The itinerary information 230 indicates the itinerary planned by the itinerary planning process. For example, the itinerary information 230 includes the point of departure DEP, the destination DST, the route, the mobility modes to be used, the takeoff and landing sites 30 to be used, the time of departure, the time of arrival, the required time from the point of departure DEP to the destination DST, and the like. The information processing device 130 stores the generated itinerary information 230 in the memory device 150.

The information processing device 130 may further generate the fee information 240 together with the itinerary information 230. The fee information 240 indicates the usage fee when the mobility service of the generated itinerary is used. The information processing device 130 stores the generated fee information 240 in the memory device 150.

### 3-3. Step S300 (Itinerary Presentation Process)

After the itinerary information 230 is generated by the itinerary planning process (Step S200), the information processing device 130 executes an “itinerary presentation process” that presents the itinerary information 230 to the user U.

More specifically, the information processing device 130 transmits the itinerary information 230 to the user terminal 50 via the communication device 120. The information processing device 53 of the user terminal 50 receives the itinerary information 230 via the communication device 52. The information processing device 53 stores the itinerary information 230 in the memory device 55. Moreover, the information processing device 53 presents the itinerary information 230 to the user U through the input/output device 51. Typically, the itinerary information 230 is displayed on the display device.

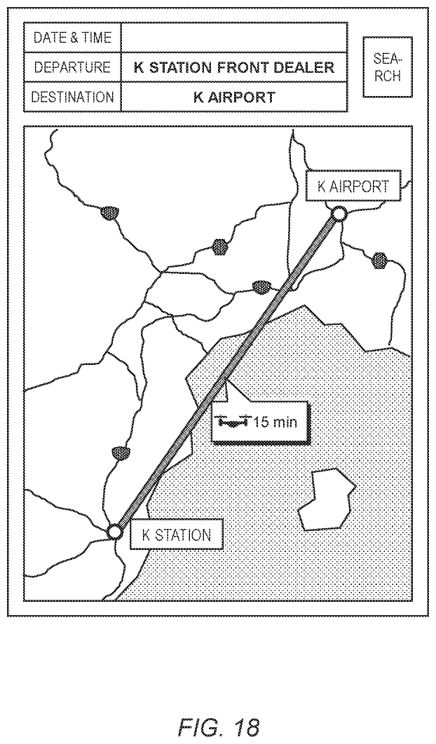

FIG. 18 is a conceptual diagram showing an example of information displayed on the display device. For simplicity, it is assumed that the point of departure DEP is the first takeoff and landing site 30-1 (e.g., K Station Front Dealer) and the destination DST is the second takeoff and landing site 30-2 (e.g., K Airport). In the example shown in FIG. 18, information of the itinerary IT_A utilizing the eVTOL 10 is displayed on the display device. More specifically, a map, the point of departure DEP, the destination DST, the route, the mobility modes (i.e., the eVTOL 10), and the required time TR-A (e.g., 15 minutes) from the point of departure DEP to the destination DST are displayed.

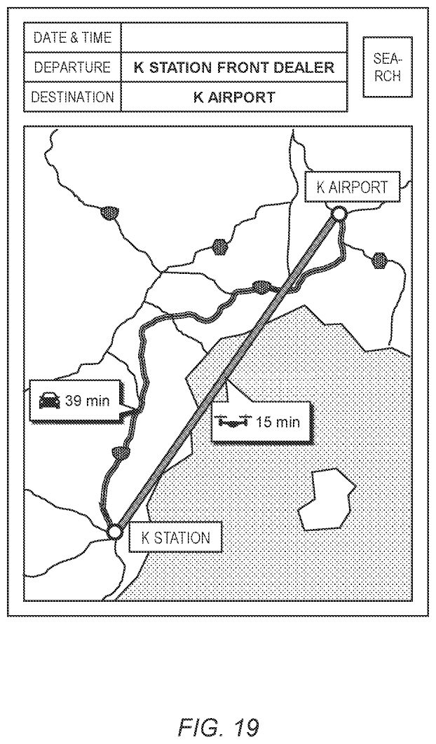

FIG. 19 is a conceptual diagram showing another example of information displayed on the display device. In the example shown in FIG. 19, information of both the itinerary IT_A and the itinerary IT_G is displayed. For example, in the case of the itinerary IT_G, the automobile is utilized and the required time TR-G from the point of departure DEP to the destination DST is 39 minutes. The user U can make a comparison of the itinerary IT_A and the itinerary IT_G.

As yet another example, only the itinerary with the shorter required time may be selectively displayed. In the same situation as shown in FIG. 19, only the information of the itinerary IT_A is selectively displayed. The information processing device 130 of the management server 100 may selectively transmit only the itinerary information 230 having the shorter required time to the user terminal 50. Alternatively, the information processing device 53 of the user terminal 50 may select the itinerary information 230 having the shorter required time.

The information processing device 130 may present the fee information 240 together with the itinerary information 230 to the user U. A method of presenting the fee information 240 is the same as in the case of the itinerary information 230.

### 3-4. Step S400 (Reservation Fix Process)

The user U considers the presented itinerary information 230 to determine whether or not to fix the reservation. When multiple itineraries are presented, the user U selects one from the multiple itineraries. For example, the user U makes a decision and choice by referring to the required time and the usage fee. When not approving the presented itinerary information 230, the user U may change the reservation request REQ. In that case, the processing returns to Step S100.

When fixing the reservation, the user U uses the input/output device 51 of the user terminal 50 to instruct to fix the reservation. When multiple itineraries are presented, the user U specifies one of the multiple itineraries. The information processing device 53 of the user terminal 50 transmits a reservation fix request to the management server 100 via the communication device 52. The information processing device 130 of the management server 100 receives the reservation fix request via the communication device 120.

In response to the reservation fix request, the information processing device 130 fixes the itinerary information 230 and the fee information 240. In addition, the information processing device 130 generates the authentication information 250. Then, the information processing device 130 generates the reservation information 220 including the itinerary information 230, the fee information 240, and the authentication information 250 (see FIG. 10). The information processing device 130 stores the reservation information 220 in the memory device 150.

Further, the information processing device 130 updates the schedule information 330 by reflecting the fixed itinerary information 230 in the schedule information 330. That is, the information processing device 130 reflects the schedules of the eVTOL 10 and the takeoff and landing sites 30 used in the fixed itinerary in the schedule information 330.

### 3-5. Step S500 (Information Sharing Process)

The information processing device 130 of the management server 100 transmits the reservation information 220 to the user terminal 50 via the communication device 120. The information processing device 53 of the user terminal 50 receives the reservation information 220 via the communication device 52. The information processing device 53 stores the reservation information 220 in the memory device 55.

The information processing device 130 of the management server 100 may transmit the user information 200 including the name of the user U, the user ID, and the itinerary information 230 to the reserved eVTOL 10. The information processing device 13 of the reserved eVTOL 10 receives the user information 200 via the communication device 12. The information processing device 13 stores the user information 200 in the memory device 15.

Similarly, the information processing device 130 of the management server 100 may transmit the user information 200 to the pilot terminal 20 used by the pilot of the reserved eVTOL 10. The information processing device 23 of the pilot terminal 20 receives the user information 200 via the communication device 22. The information processing device 23 stores the user information 200 in the memory device 25.

Similarly, the information processing device 130 of the management server 100 may transmit the user information 200 to the local terminal 40 installed in the reserved takeoff and landing site 30. The information processing device 43 of the local terminal 40 receives the user information 200 via the communication device 42. The information processing device 43 stores the user information 200 in the memory device 45.

### 4. CHECK-IN PROCESS (PICK UP)

At the first takeoff and landing site 30-1, the eVTOL 10 picks up the user U. That is, at the first takeoff and landing site 30-1, the user U boards the reserved eVTOL 10. After the user U boards the eVTOL 10, the eVTOL 10 takes off.

Before the boarding, a “user authentication process” that authenticates the user U may be performed. As an example, the user authentication process performed by the pilot terminal 20 and the management server 100 will be described. The same applies to a case where the eVTOL 10 or the local terminal 40 is used instead of the pilot terminal 20.

First, the user U provides the pilot terminal 20 with the authentication information 250 stored in the user terminal 50. For example, the communication device 52 of the user terminal 50 and the communication device 22 of the pilot terminal 20 perform the near field communication, and thereby the authentication information 250 is transmitted from the user terminal 50 to the pilot terminal 20. As another example, in a case where the authentication information 250 is a QR code, the user U may display the QR code on the display device. In this case, the camera or the like of the pilot terminal 20 reads the QR code displayed on the display device of the user terminal 50.

The information processing device 23 of the pilot terminal 20 transmits the acquired authentication information 250 to the management server 100. The information processing device 130 of the management server 100 authenticates the user U by checking the received authentication information 250 against the reservation information 220 stored in the memory device 150. Then, the information processing device 130 transmits the authentication result to the pilot terminal 20. The information processing device 23 of the pilot terminal 20 receives the authentication result. Alternatively, when the pilot terminal 20 holds the reservation information 220, the information processing device 23 may authenticate the user U by checking the authentication information 250 against the reservation information 220.

### 5. TRANSPORTATION SERVICE IN TAKEOFF AND LANDING SITE

### 5-1. Transportation Service

It is conceivable that a passenger getting off from an eVTOL 10 landed on a takeoff and landing site 30 walks to a building or a transit point in the takeoff and landing site 30. It is also conceivable that a passenger walks from a waiting lounge to an eVTOL 10 when boarding the eVTOL 10. However, some passengers may desire transportation to and from the eVTOL 10. For example, a physically disabled passenger may desire transportation to and from the eVTOL 10. To meet such demands is important for the mobility service. In view of the above, according to the present embodiment, a “transportation service” in the takeoff and landing site 30 is delivered as a part of the mobility service.

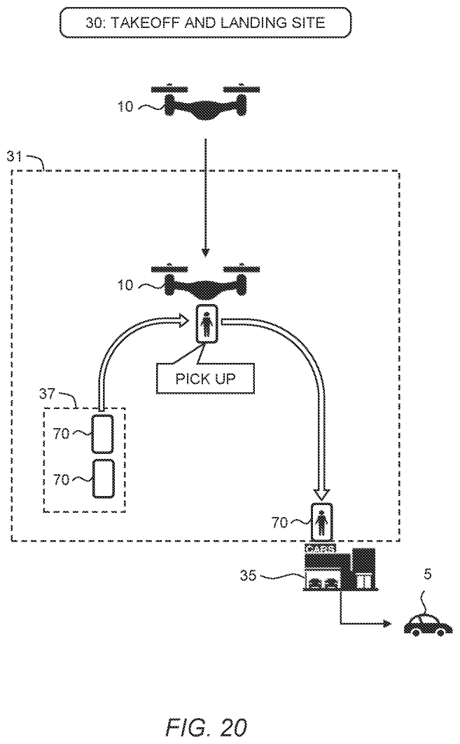

FIG. 20 is a conceptual diagram for explaining the transportation service in the takeoff and landing site 30. A moving body (or a mobility) 70 capable of autonomously traveling in the takeoff and landing site 30 is used for the transportation service. The moving body 70 takes a passenger to and from the eVTOL 10 landed on the takeoff and landing site 30.

As an example, FIG. 20 shows a situation where the moving body 70 picks a passenger up. The moving body 70 autonomously travels from a waiting area 37 toward the eVTOL 10 landed. The moving body 70 arriving near the eVTOL 10 lets the passenger on. After that, the moving body 70 on which the passenger rides travels autonomously to a transit point to a next mobility modes (e.g., ride sharing).

### 5-2. Example of Moving Body

Next, an example of the moving body 70 used for the transportation service will be described. A usual automobile or bus may interfere with a rotor of the eVTOL 10. Therefore, in the present embodiment, a small moving body 70 is used for the transportation service.

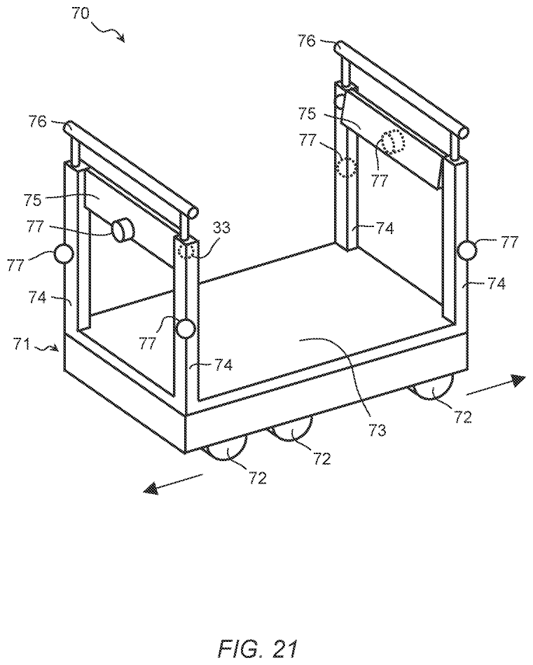

FIG. 21 is a perspective view showing a configuration example of the moving body 70. The moving body 70 includes a carriage 71. The carriage 71 has a plurality of wheels 72 and a motor driving the wheels 72, and provides a traveling function of the moving body 70.

The moving body 70 further incudes a floor board 73. The floor board 73 is installed on the carriage 71. The floor board 73 may be separated from the carriage 71 or may be formed integrally with the carriage 71. The passenger rides on the floor board 73. For example, the passenger stands on the floor board 73. A chair on which the passenger sits may be installed on the floor board 73. In any case, a space above the floor board 73 is a riding space for the passenger.

The configuration of the riding space is arbitrary. In the example shown in FIG. 21, supports 74 are erected at four corners of the floor board 73. A backrest 75 is provided between the left and right supports 74. A standing passenger can lean against the backrest 75. A handrail 76 is provided above the support 74 and the backrest 75. The passenger can grasp the handrail 76.

The moving body 70 further includes a sensor group 77. For example, the sensor group 77 includes a recognition sensor for recognizing a situation around the moving body 70. Examples of the recognition sensor include a camera and a LIDAR (LIght Detection And Ranging). For example, four cameras respectively attached to the four supports 74 capture images of the right front side, the left front side, the right rear side, and the left rear side of the moving body 70. As another example, two LIDARs attached to a front surface and a rear surface of the moving body 70, respectively, detect objects in front of and behind the moving body 70.

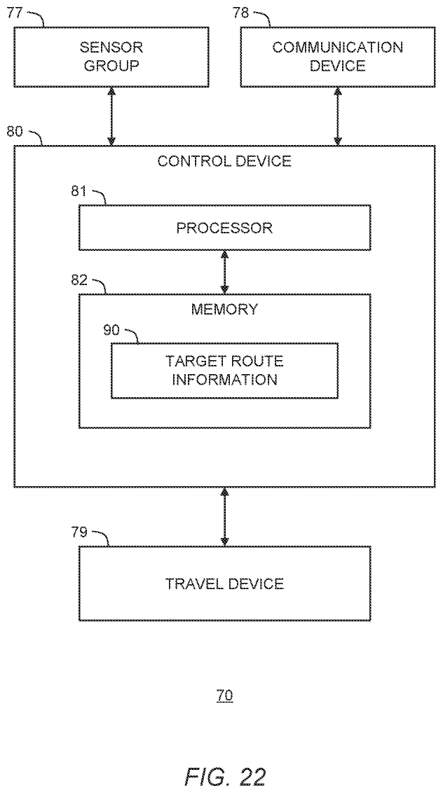

FIG. 22 is a block diagram showing a configuration example of the moving body 70. The moving body 70 includes the sensor group 77, a communication device 78, a travel device 79, and a control device 80.

The sensor group 77 includes a position sensor, a vehicle state sensor, and the like in addition to the recognition sensor descried above. The position sensor acquires a position and an azimuth of the moving body 70. Examples of the position sensor include a GNSS (Global Navigation Satellite System) receiver. The vehicle state sensor detects a speed, an acceleration (e.g., a longitudinal acceleration, a lateral acceleration, and the like), and an angular velocity (e.g., a yaw rate, and the like).

The communication device 78 communicates with the outside of the moving body 70. For example, the communication device 78 performs communication using a wireless communication network such as 4G or 5G. The communication device 78 may be connected to a wireless LAN. The communication device 78 may perform direct communication (near field communication) with the user terminal 50 of the passenger.

The travel device 79 accelerates, decelerates, and turns the moving body 70. The travel device 79 includes motors for driving the wheels 72. Acceleration and deceleration of the moving body 70 are performed by controlling the motors. Braking may be performed by the use of regenerative braking by control of the motors. In some embodiments, at least one wheel 72 may be provided with a mechanical brake. Turning of the moving body 70 can be realized by controlling a difference in rotation speed between the left and right wheels 72 (motors). A steering mechanism that steers the wheels 72 may be provided.

The control device (controller) 80 is a computer that controls the moving body 70. The control device 80 includes at least one processor 81 and at least one memory 82. The processor 81 performs a variety of information processing. For example, the processor 81 includes a central processing unit (CPU). The memory 82 stores a variety of information necessary for the processing by the processor 81. Examples of the memory 82 include a volatile memory, a nonvolatile memory, a hard disk drive (HDD), and the like. The processor 81 executes a computer program. The functions of the control device 80 are implemented by a cooperation of the processor 81 executing the computer program and the memory 82.

The control device 80 receives a variety of information acquired by the sensor group 77 and stores the received information in the memory 82. In addition, the control device 80 communicates with the outside via the communication device 78.

Further, the control device 80 performs vehicle travel control (acceleration control, deceleration control, turning control) by controlling the travel device 79. The speed, the acceleration, and the angular velocity of the moving body 70 are detected by the vehicle state sensor described above. The control device 80 may perform the vehicle travel control so as to avoid a collision with an object around the moving body 70. The object around the moving body 70 is recognized by the recognition sensor described above.

Especially, the control device 80 performs the vehicle travel control such that the moving body 70 travels autonomously. More specifically, the control device 80 acquires target route information 90. The target route information 90 indicates a target route RT of the moving body 70 at the time of the transportation service in the takeoff and landing site 30. For example, the target route RT is embedded in map information of the takeoff and landing site 30. A method of acquiring the target route information 90 will be described later in detail. The target route information 90 is stored in the memory 82. A current position of the moving body 70 is acquired by the position sensor described above. The control device 80 performs the vehicle travel control such that the moving body 70 travels along the target route RT.

### 5-3. Target Route Determination Process

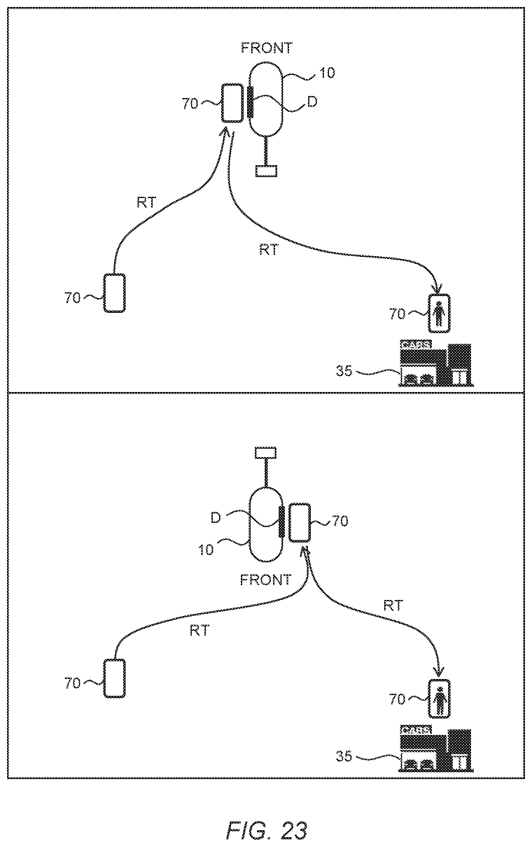

FIG. 23 shows an example of the target route RT of the moving body 70 at the time of the transportation service. The eVTOL 10 has a boarding door D through which the passenger gets on and off. In order to achieve a smooth transportation service, the moving body 70 may move to right next to the boarding door D of the eVTOL 10.

However, since the eVTOL 10 is of the vertical takeoff and landing type, a position and an azimuth of the eVTOL 10 at the time of landing are not always fixed. The position and the azimuth of the eVTOL 10 at the time of landing may vary every time. In particular, as shown in FIG. 23, an orientation of the boarding door D varies depending on the azimuth of the eVTOL 10 at the time of landing. When the orientation of the boarding door D varies, a relative positional relationship between the boarding door D and the moving body 70 also varies and thus the target route RT for approaching the side of the boarding door D also varies. Therefore, the target route RT of the moving body 70 may be determined in consideration of the azimuth of the eVTOL 10 or the relative positional relationship between the boarding door D (eVTOL 10) and the moving body 70.

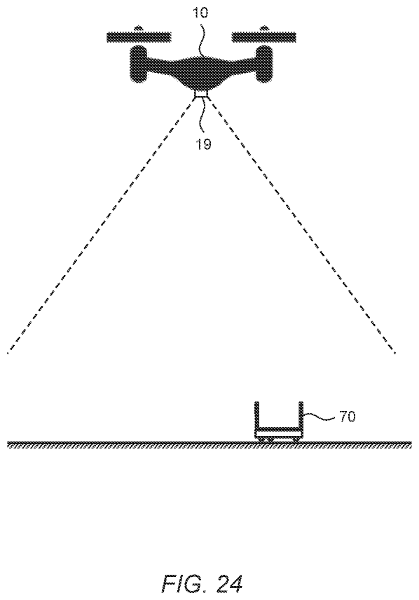

According to the present embodiment, a sensor 19 installed on the eVTOL 10 is used for determining the target route RT of the moving body 70. For example, as shown in FIG. 24, the sensor 19 includes at least one of a camera and a LIDAR. The camera or the LIDAR images or measures a situation in a ground direction. Based on a result of imaging by the camera or a result of measurement by the LIDAR, it is possible to recognize the moving body 70 on the ground and to further calculate the relative positional relationship between the eVTOL 10 and the moving body 70. The relative positional relationship includes a relative distance and a relative direction.

As another example, the sensor 19 may include an electronic compass that detects the azimuth of the eVTOL 10.

Information thus detected by using the sensor 19 installed on the eVTOL 10 is hereinafter referred to as “sensor detection information.” The sensor detection information includes at least one of the azimuth of the eVTOL 10 and the relative positional relationship between the eVTOL 10 and the moving body 70.

According to the present embodiment, the target route RT of the moving body 70 at the time of the transportation service is determined based on the sensor detection information and an installation position of the boarding door D of the eVTOL 10. More specifically, as shown in FIG. 23, the target route RT is determined such that the moving body 70 is able to move to a side of the boarding door D of the eVTOL 10.

For example, the case where the sensor 19 includes at least one of the camera and the LIDAR is considered. In this case, the sensor detection information includes the relative positional relationship between the eVTOL 10 (the sensor 19) and the moving body 70. An installation position and an installation orientation of the sensor 19 and the installation position of the boarding door D on the eVTOL body are known information and acquired from the aircraft information 310 for example. It is possible to determine the target route RT based on the sensor detection information (i.e., the relative positional relationship), the installation position and the installation orientation of the sensor 19, and the installation position of the boarding door D.

As another example, the case where the sensor 19 includes the electronic compass. In this case, the sensor detection information includes the azimuth of the eVTOL 10. Information on the landing position of the eVTOL 10 is provided from the eVTOL 10. As another example, the control device 80 of the moving body 70 may identify the eVTOL 10 based on the result of recognition by the recognition sensor to calculate the landing position of the eVTOL 10. It is possible to determine the target route RT based on the sensor detection information (i.e., the azimuth of the eVTOL 10), the landing position of the eVTOL 10, and the installation position of the boarding door D.

The moving body 70 autonomously travels along the target route RT to the side of the boarding door D of the eVTOL 10 landed. As a result, a smooth transportation service is achieved.

### 5-4. Process Flow

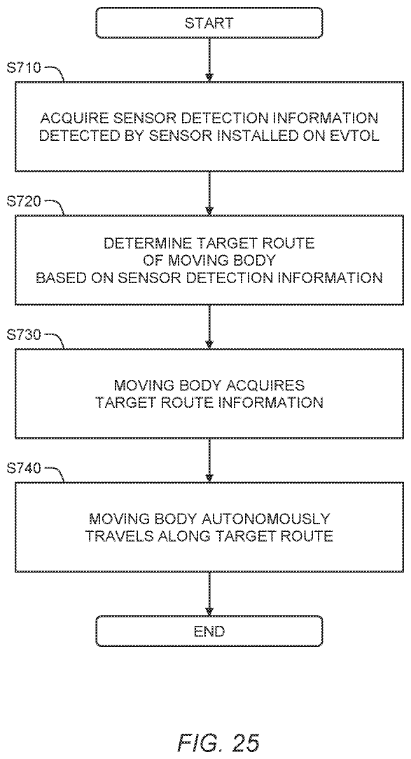

FIG. 25 is flow chart showing processing related to the transportation service according to the present embodiment.

### 5-4-1. Step S710

In Step S710, the information processing device 13 of the eVTOL 10 acquires the sensor detection information by using the sensor 19. As described above, the sensor detection information includes at least one of the azimuth of the eVTOL 10 and the relative positional relationship between the eVTOL 10 and the moving body 70. Typically, the sensor detection information is acquired while the eVTOL 10 is performing a landing operation with respect to a landing point. Alternatively, the sensor detection information may be acquired after the eVTOL 10 completes the landing on the landing point.

The information processing device 13 of the eVTOL 10 may transmit the sensor detection information to an external device through the communication device 12. For example, the information processing device 13 may transmit the sensor detection information to the management server 100. The information processing device 13 may transmit the sensor detection information to the local terminal 40. The information processing device 13 may transmit the sensor detection information to the moving body 70. In these cases, the external device also acquires the sensor detection information.

### 5-4-2. Step S720

In Step S720, the target route RT of the moving body 70 at the time of the transportation service is determined. As shown in FIG. 23, the target route RT is determined such that the moving body 70 is able to move to the side of the boarding door D of the eVTOL 10. As described above, such the target route RT can be determined based on the sensor detection information and the installation position of the boarding door D of the eVTOL 10 (see Section 5-3).

A final destination of the target route RT may be predetermined or may be set for each passenger. For example, when the passenger transits (transfers) from the eVTOL 10 to a next mobility modes (e.g., ride sharing), the final destination of the target route RT is the transit point. The fact that the passenger plans to transit can be known from the reservation information 220 (itinerary information 230). When there is no transit in particular, the final destination of the target route RT may be a predetermined location (e.g., a lobby).

A subject of Step S720 is not limited in particular. For example, the information processing device 13 (i.e., the processor 14) of the eVTOL 10 executes Step S720. As another example, the information processing device 130 (i.e., the processor 140) of the management server 100 may execute Step S720. As yet another example, the information processing device 43 (i.e., the processor 44) of the local terminal 40 may execute Step S720. As yet another example, the control device 80 (i.e., the processor 81) of the moving body 70 may execute Step S720. Information necessary for Step S720 is acquired through communication.

Steps S710 and S720 described above correspond to the “target route determination process.” To generalize, one or more processors execute the target route determination process.

### 5-4-3. Step S730

In Step S730, the control device 80 of the moving body 70 acquires the target route information 90 indicating the target route RT from the subject determining the target route RT. Here, the control device 80 performs communication as necessary to acquire the target route information 90. The target route information 90 is stored in the memory 82 (see FIG. 22).

### 5-4-4. Step S740

In Step S740, the control device 80 of the moving body 70 performs the vehicle travel control such that the moving body 70 autonomously travels along the target route RT. At this time, the moving body 70 moves along the target route RT to the side of the boarding door D of the eVTOL 10. As a result, a smooth transportation service is achieved.

It should be noted that the moving body 70 may move toward the eVTOL 10 in stages. For example, the moving body 70 may start moving and move to a middle point before the eVTOL 10 while the eVTOL 10 performs the landing operation. Then, after completion of the landing of the eVTOL 10, the moving body 70 moves to the side of the boarding door D of the eVTOL 10.

### 5-5. Another Example

The information processing device 13 of the eVTOL 10 may display the position of the moving body 70 on a display device for the pilot (i.e., input/output device 11). The pilot is able to perform the landing operation of the eVTOL 10 with a landing angle that enables the moving body 70 to smoothly approach the eVTOL 10.

What is claimed is:

1. A mobility service system that delivers a mobility service utilizing an electric vertical takeoff and landing aircraft (hereinafter referred to as an eVTOL), wherein the mobility service includes a transportation service where a moving body capable of autonomously traveling in a takeoff and landing site takes a passenger to and from an eVTOL landed on the takeoff and landing site,
the mobility service system comprising one or more processors configure to determine a target route of the moving body in the transportation service, wherein
the one or more processors are further configured to acquire sensor detection information that is detected by a sensor installed on the eVTOL,
the sensor detection information includes at least one of an azimuth of the eVTOL and a relative positional relationship between the eVTOL and the moving body, and
the one or more processors are further configured to determine the target route such that the moving body moves to a side of a boarding door of the eVTOL, based on the sensor detection information and an installation position of the boarding door of the eVTOL.

2. The mobility service system according to claim 1, wherein
the one or more processors are further configured to provide the moving body with target route information indicating the target route, and
the moving body moves along the target route to the side of the boarding door of the eVTOL landed on the takeoff and landing site.

3. A mobility service delivery method that delivers a mobility service utilizing an electric vertical takeoff and landing aircraft (hereinafter referred to as an eVTOL), wherein the mobility service delivery method is performed by a computer executing a computer program, and the mobility service includes a transportation service where a moving body capable of autonomously traveling in a takeoff and landing site takes a passenger to and from an eVTOL landed on the takeoff and landing site,
the mobility service delivery method comprising a target route determination process that determines a target route of the moving body in the transportation service, wherein
the target route determination process includes acquiring sensor detection information that is detected by a sensor installed on the eVTOL,
the sensor detection information includes at least one of an azimuth of the eVTOL and a relative positional relationship between the eVTOL and the moving body, and
the target route determination process further includes determining the target route such that the moving body moves to a side of a boarding door of the eVTOL, based on the sensor detection information and an installation position of the boarding door of the eVTOL.

4. The mobility service delivery method according to claim 3, further comprising a process that the moving body moves along the target route to the side of the boarding door of the eVTOL landed on the takeoff and landing site.
